(19) United States
(12) Patent Application Publication
(10) Pub. No.: US 2017/0345456 A1
(43) Pub. Date: Nov. 30, 2017

(54) PROGRAMMABLE ERROR-CORRECTING CODE FOR A HOST DEVICE

(71) Applicant: HGST Netherlands B.V., Amsterdam (NL)

(72) Inventors: Martin Aureliano Hassner, Mountain View, CA (US); Kirk Hwang, Palo Alto, CA (US); Laurence Morris Morkre, Superior, CO (US); Satoshi Yamamoto, San Jose, CA (US)

(21) Appl. No.: 15/165,704

(22) Filed: May 26, 2016

(51) Int. Cl. G11B 20/18; G06F 11/10

(52) U.S. Cl. CPC G11B 20/1833; G06F 11/1076

(57) ABSTRACT

In one example, the disclosure is directed to error-correcting code techniques for managing data by a host device. In some examples, in writing the data, a host device receives parity data, data and one or more error pointers from a storage device. Each respective error pointer references a location of a respective data sector of the data that contains an error. The host device determines, based at least in part on the one or more error pointers, a first data sector of the data that contains an error. The host device recovers, based at least in part on the parity data, the data, and the one or more error pointers, the first data sector.

### TECHNICAL FIELD

The disclosure relates to error correction for storage devices, such as hard disk drives.

### BACKGROUND

An error-correcting code (ECC) is a system of adding redundant data, or parity data, to a message, such that the data can be recovered by a receiver even when a number of errors (up to the capability of the code being used) are introduced in the data. A cold storage shingled-magnetic recording (SMR) drive is utilized in archival applications that require increased capacities, which are obtained by increasing the tracks per inch (TPI) present in the drive by partially overlapping adjacent data tracks. At the same time, equivalent data integrity as present in a conventional hard disk drive is desired. For this reason, a write verify function may be implemented to increase data reliability in conventional Cold Storage SMR drives. However, the write verify function decreases write command throughput due to an additional written data verify process. Write command throughput with the write verify function may result in an at least 55% loss of performance (e.g., throughput) when compared to a write process without the write verify function.

### SUMMARY

In one example, the disclosure is directed to a method including receiving, by a host device and from a storage device, parity data, data and one or more error pointers, wherein each respective error pointer references a location of a respective data sector of the data that contains an error, determining, by the host device and based at least in part on the one or more error pointers, a first data sector of the data that contains an error, and recovering, by the host device and based at least in part on the parity data, the data, and the one or more error pointers, the first data sector.

In another example, the disclosure is directed to a host device including at least one processor and a storage device configured to store one or more modules operable by the at least one processor to receive, from a storage device, parity data, data and one or more error pointers, wherein each respective error pointer references a location of a respective data sector of the data that contains an error, determine, based at least in part on the one or more error pointers, a first data sector of the data that contains an error, and recover, based at least in part on the parity data, the data, and the one or more error pointers, the first data sector.

In another example, the disclosure is directed to a host device including means for receiving, from a storage device, parity data, data, and one or more error pointers, wherein each respective error pointer references a location of a respective data sector of the data that contains an error, means for determining, based at least in part on the one or more error pointers, a first data sector that contains an error, and means for recovering, based at least in part on the parity matrix, the data matrix, and the one or more error pointers, the first data sector.

In another example, the disclosure is directed to a computer-readable medium containing instructions that, when executed, cause a controller of a host device to receive, from a storage device, parity data, data and one or more error pointers, wherein each respective error pointer references a location of a respective data sector of the data that contains an error, determine, based at least in part on the one or more error pointers, a first data sector of the data that contains an error, and recover, based at least in part on the parity data, the data, and the one or more error pointers, the first data sector.

The details of one or more examples of the disclosure are set forth in the accompanying drawings and the description below. Other features, objects, and advantages of the disclosure will be apparent from the description and drawings, and from the claims.

### BRIEF DESCRIPTION OF DRAWINGS

FIG. 1 is a conceptual and schematic block diagram illustrating an example storage environment that includes a data storage device and a host device, in accordance with one or more techniques of this disclosure.

FIG. 2 is a block diagram illustrating the data storage device and host device of FIG. 1 in more detail.

FIG. 3 is a conceptual diagram illustrating an example process of a host device receiving error-laden data and a logical block address list from a controller device, in accordance with one or more techniques of this disclosure.

FIG. 4 is a flow diagram illustrating an exemplary operation of a host device in performing the error-correcting code operations, in accordance with one or more techniques of this disclosure.

FIG. 5 is a flow diagram illustrating an exemplary operation of a host device in performing a particular error-correcting code operation, in accordance with one or more techniques of this disclosure.

### DETAILED DESCRIPTION

In general, this disclosure describes techniques for utilizing error-correcting code (FCC) within a host device when writing and reading data in a data storage device, such as a cold storage shingled-magnetic recording (SMR) drive. Rather than attempting to correct all data errors in the data storage device prior to transferring the data to the host device, and not transferring data including uncorrected errors to the host device, the data storage device may transfer and the host device may receive data with errors still present throughout the data. Upon receiving the error-laden data, the host device may utilize ECC techniques to recover portions of the data that contain the errors more efficiently than if similar techniques were performed within the data storage device.

Performing ECC techniques in the host device may lead to numerous benefits. For example, when a host device implements the ECC described herein, the host device and data storage device may omit a write verify function, which may increase the operating efficiency (e.g., write throughput) of the read and write process. In many write verify functions, a physical platter of the cold storage SMR drive containing the data being verified makes a full revolution for each file being verified. This is because once the data is written, the platter must spin such that the read/write head is back at the starting position of the file. When the files being verified are small, this full revolution may be greatly inefficient, as the platter must perform this rotation in addition to performing the general verify functions. Rather than (or in addition to) implementing a write verify algorithm, techniques of this disclosure enable a processor to calculate the parity matrix using only two matrix cross multiplication operations that may be performed without having to read back what was initially written to the hard drive. Further, even though the verify function may alert the host device that an error was encountered in writing the data, data may still be lost over time due to various environmental factors or mechanical limitations. As such, when reading the data, the data may still have to be checked for errors, especially in a cold storage environment (i.e., an environment where large amounts of data are stored and may not be accessed for long periods of time). The necessity to re-check the data upon reading the data makes the write verify function superfluous in many practical situations. Rather than performing the write verify function upon writing, the creation of the parity matrix described herein, which may be used to recover various sectors in tracks of data may increase the speed and efficiency of a host device managing the cold storage SMR drive with a minimal additional burden of storing the parity matrix data. Further, by performing the ECC techniques within the host device, the techniques may be performed more efficiently than if the same techniques were performed in a controller of the SMR drive or the FCC techniques may be more computationally intensive, as the host device generally has more processing power than the controller.

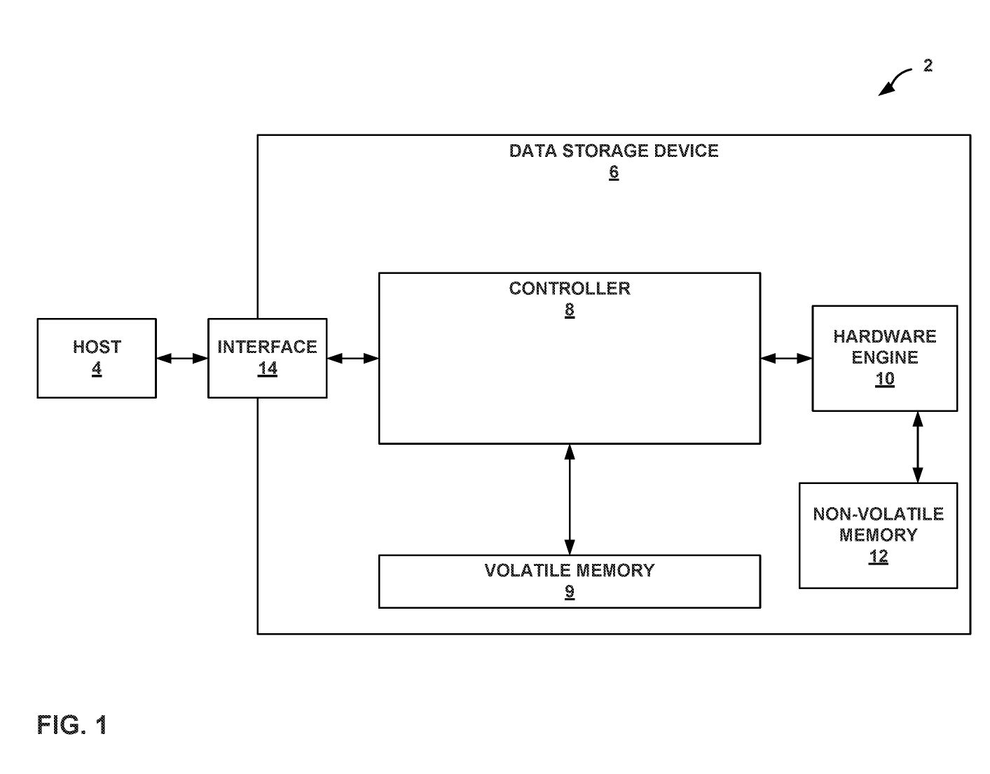

FIG. 1 is a conceptual and schematic block diagram illustrating an example storage environment 2 in which data storage device 6 may function as a storage device for host device 4, in accordance with one or more techniques of this disclosure. For instance, host device 4 may utilize non-volatile memory devices included in data storage device 6, such as non-volatile memory 12, to store and retrieve data. In some examples, storage environment 2 may include a plurality of storage devices, such as data storage device 6, which may operate as a storage array. For instance, storage environment 2 may include a plurality of hard drives 6 configured as a redundant array of inexpensive/independent disks (RAM) that collectively function as a mass storage device for host device 4. While techniques of this disclosure generally refer to storage environment 2 and data storage device 6, techniques described herein may be performed in any storage environment that utilizes tracks of data.

Storage environment 2 may include host device 4 which may store and/or retrieve data to and/or from one or more storage devices, such as data storage device 6. As illustrated in FIG. 1, host device 4 may communicate with data storage device 6 via interface 14. Host device 4 may include any of a wide range of devices, including computer servers, network attached storage (NAS) units, desktop computers, notebook (i.e., laptop) computers, tablet computers, set-top boxes, telephone handsets such as so-called “smart” phones, so-called “smart” pads, televisions, cameras, display devices, digital media players, video gaming consoles, video streaming device, and the like.

Typically, host device 4 includes any device having a processing unit, which may refer to any form of hardware capable of processing data and may include a general purpose processing unit (such as a central processing unit (CPU), dedicated hardware (such as an application specific integrated circuit (ASIC)), configurable hardware such as a field programmable gate array (FPGA) or any other form of processing unit configured by way of software instructions, microcode, firmware, or the like.

As illustrated in FIG. 1 data storage device 6 may include a controller 8, a volatile memory 9, a hardware engine 10, non-volatile memory 12, and an interface 14. In some examples, data storage device 6 may include additional components not shown in FIG. 1 for ease of illustration purposes. For example, data storage device 6 may include power delivery components, including, for example, a capacitor, super capacitor, or battery; a printed board (PB) to which components of data storage device 6 are mechanically attached and which includes electrically conductive traces that electrically interconnect components of data storage device 6, and the like. In some examples, the physical dimensions and connector configurations of data storage device 6 may conform to one or more standard form factors. Some example standard form factors include, but are not limited to, 3.5″ hard disk drive (HDD), 2.5″ HDD, or 1.8″ HDD.

In some examples, volatile memory 9 may store information for processing during operation of data storage device 6. In some examples, volatile memory 9 is a temporary memory, meaning that a primary purpose of volatile memory 9 is not long-term storage. Volatile memory 9 on data storage device 6 may configured for short-term storage of information as volatile memory and therefore not retain stored contents if powered off. Examples of volatile memories include random access memories (RAM), dynamic random access memories (DRAM), static random access memories (SRAM), and other forms of volatile memories known in the art.

In some examples, data storage device 6 may be an SMR drive. With SMR, tracks are written to non-volatile memory 12 and successively written data tracks partially overlap the previously written data tracks, which typically increases the data density of non-volatile memory 12 by packing the tracks closer together. In some examples in which data storage device 6 is an SMR drive, data storage device 6 may also include portions of non-volatile memory 12 that do not include partially overlapping data tracks and are thus configured to facilitate random writing and reading of data. To accommodate the random access zones, portions of non-volatile memory 12 may have tracks spaced farther apart than in the sequential, SMR zone.

Non-volatile memory 12 may be configured to store larger amounts of information than volatile memory 9. Non-volatile memory 12 may further be configured for long-term storage of information as non-volatile memory space and retain information after power on/off cycles. Examples of non-volatile memories include magnetic media, optical disks, floppy disks, flash memories, ferroelectric random access memory (FeRAM), magnetoresistive random access memory (MRAM), phase-change memory (PCRAM), or forms of electrically programmable memories (EPROM) or electrically erasable and programmable memories (EEPROM). Non-volatile memory 12 may be one or more magnetic platters in data storage device 6, each platter containing one or more regions of one or more tracks of data.

Data storage device 6 may include interface 14 for interfacing with host device 4. Interface 14 may include one or both of a data bus for exchanging data with host device 4 and a control bus for exchanging commands with host device 4. Interface 14 may operate in accordance with any suitable protocol. For example, interface 14 may operate in accordance with one or more of the following protocols: advanced technology attachment (ATA) serial-ATA (SATA), and parallel-ATA (PATA)), Fibre Channel, small computer system interface (SCSI), serially attached SCSI (SAS), peripheral component interconnect (PCI), PCI-express (PCIe), and non-volatile memory express (NVMe). The electrical connection of interface 14 (e.g., the data bus, the control bus, or both) is electrically connected to controller 8, providing electrical connection between host device 4 and controller 8, allowing data to be exchanged between host device 4 and controller 8. In some examples, the electrical connection of interface 14 may also permit data storage device 6 to receive power from host device 4.

In the example of FIG. 1, data storage device 6 includes hardware engine 10, which may represent the hardware responsible for interfacing with the storage medium. Hardware engine 10 may, in the context of a platter-based hard drive, represent the magnetic read/write head and the accompanying hardware to configure, drive and process the signals sensed by the magnetic read/write head.

Data storage device 6 includes controller 8, which may manage one or more operations of data storage device 6. Controller 8 may interface with host device 4 via interface 14 and manage the storage of data to and the retrieval of data from non-volatile memory 12 accessible via hardware engine 10. Controller 8 may, as one example, manage writes to and reads from the memory devices, e.g., volatile memory 9 and non-volatile memory 12. In some examples, controller 8 may be a hardware controller. In other examples, controller 8 may be implemented into data storage device 6 as a software controller.

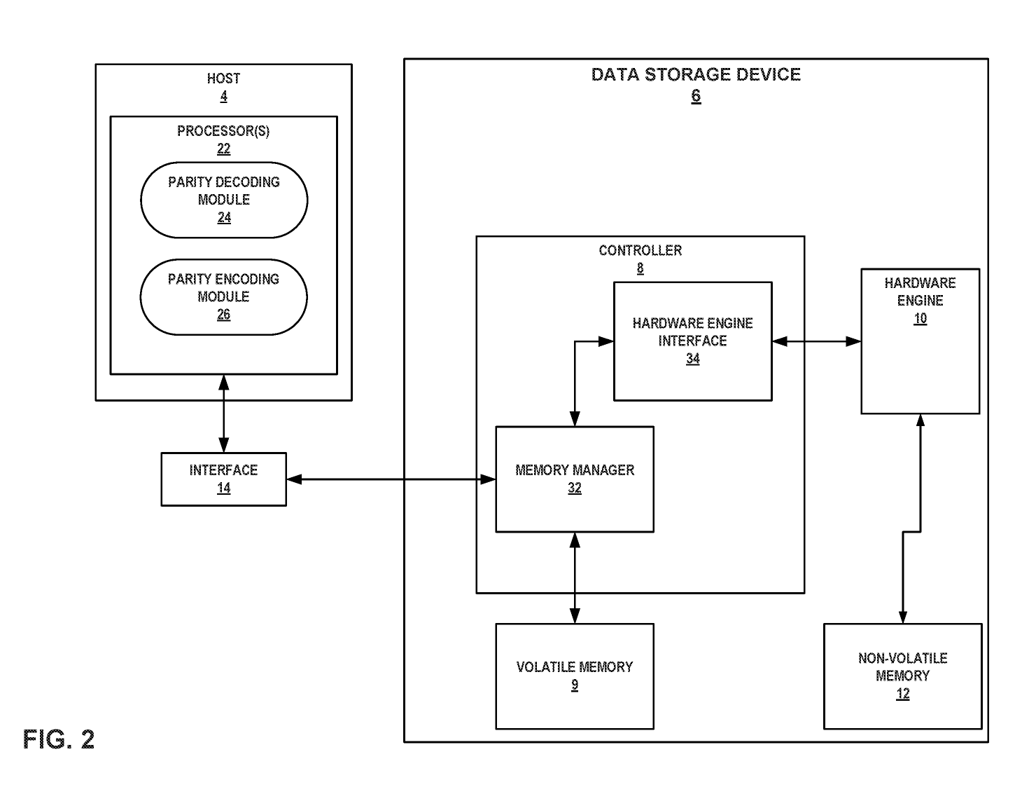

Host 4 may execute software, such as the above noted operating system, to manage interactions between host 4 and hardware engine 10. The operating system may perform arbitration in the context of multi-core CPUs, where each core effectively represents a different CPU, to determine which of the CPUs may access hardware engine 10. The operating system may also perform queue management within the context of a single CPU to address how various events, such as read and write requests in the example of data storage device 6, issued by host 4 should be processed by hardware engine 10 of data storage device 6. Host 4 may further include one or more components or modules that may perform techniques of this disclosure, such as parity decoding module 24 (as shown in FIG. 2).

In accordance with the techniques of this disclosure, when host 4 is causing controller 8 to read the data from NVM 12, host 4 may receive parity data and data, e.g., from hardware engine 10 via controller 8. Host 4 may also receive one or more error pointers. Each respective error pointer may reference a location of a respective data sector of the data that contains an error.

Host 4 may determine, based at least in part on the one or more error pointers, a first data sector of the data that contains an error. For instance, the received data may include ten different data sectors, or subdivisions of a track on NVM 12 that stores a fixed amount of user-accessible data. The received error pointers may reference data sectors three and seven of the ten data sectors. As such, host 4 may determine that the third data sector and the seventh data sector contain errors.

Host 4 may then recover the first data sector based at least in part on the parity data, the data, and the one or more error pointers. For instance, using the parity data and error correction techniques that may utilize the data and the one or more error pointers, host 4 may recover the third data sector and/or the seventh data sector, such that the data is in a usable state.

In some examples, host 4 may generate the parity data prior to causing controller 8 to write data to NVM 12. For example, host 4 may generate the parity data based on the data to be written to NVM 12, and may communicate the data and the parity data to controller 8 with an instruction to controller 8 to write the data to NVM 12.

By using the techniques described above, host 4, controller 8, or both may omit a write verify function, which may increase the operating efficiency (e.g., write throughput) of the read and write process. Further, even though the verify function may alert the host device that an error was encountered in writing the data, data may still be lost over time due to various environmental factors or mechanical limitations. As such, when reading the data, the data may still have to be checked for errors, especially in a cold storage environment (i.e., an environment where large amounts of data are stored and may not be accessed for long periods of time). The necessity to re-check the data upon reading the data makes the write verify function superfluous in many practical situations. Rather than performing the write verify function upon writing, the creation of the parity data described herein, which may be used to recover various sectors in tracks of data may increase the speed and efficiency of a host device managing the cold storage SMR drive with a minimal additional burden of storing the parity matrix data. Further, by performing the ECC techniques within host 4, the techniques may be performed more efficiently than if the same techniques were performed in controller 8, as host 4 device generally has more processing power than controller 8.

The techniques described herein may be combined with other ECC techniques, such as HDD track ECC. For instance, controller 8 may first use HDD track ECC to recover up to a predefined number of sectors (e.g., up to 4 sectors) that contain an error (e.g., up to a predefined number of sectors per track). Controller 8 may generate an error pointer for each sector that controller 8 does not recover. Controller 8 may communicate the data (e.g., the partially recovered data), the parity data, and the error pointer(s) to host 4, and host 4 may recover the remaining error sectors using the techniques described herein.

FIG. 2 is a block diagram illustrating data storage device 6 and host 4 of FIG. 1 in more detail. In the example of FIG. 2, host 4 includes one or more processors 22, which includes a parity decoding module 24 and a parity encoding module 26. Data storage device 6 includes controller 8, volatile memory 9, hardware engine 10, and non-volatile memory 12, as described above with respect to FIG. 1. Controller 8 includes a memory manager 32 and a hardware engine interface 34. Host 4 and data storage device 6 are connected via interface 14.

Memory manager unit 32 and hardware engine interface unit 34 may perform various functions typical of a controller of a data storage device. For instance, hardware engine interface unit 34 may represent a unit configured to facilitate communications between controller 8 and hardware engine 10. Hardware engine interface unit 34 may present a standardized or uniform way by which to interface with hardware engine 10. Hardware engine interface 34 may provide various configuration data and events to hardware engine 10, which may then process the event in accordance with the configuration data, returning various different types of information depending on the event. In the context of an event requesting that data be read (e.g., a read request), hardware engine 10 may return the data to hardware engine interface 34, which may pass the data to memory manager unit 32. Memory manager unit 32 may store the read data to volatile memory 9 and return a pointer or other indication of where this read data is stored to hardware engine interface 34. In the context of an event involving a request to write data (e.g. a write request), hardware engine 10 may return an indication that the write has completed to hardware engine interface unit 34. In this respect, hardware engine interface unit 34 may provide a protocol and handshake mechanism with which to interface with hardware engine 10.

One or more processors 22 of host 4, in one example, are configured to implement functionality and/or process instructions for execution within host 4. For example, one or more processors 22 may be capable of processing instructions stored in storage device 23. Examples of one or more processors 22 may include, any one or more of a microprocessor, a controller, a digital signal processor (DSP), an application specific integrated circuit (ASIC), a field-programmable gate array (FPGA), a graphics processing unit (GPU) or equivalent discrete or integrated logic circuitry.

Processors 22 of host 4 include or execute various modules, including parity decoding module 24 and parity encoding module 26. The various modules of controller 8 may be configured to perform various techniques of this disclosure, including the technique described above with respect to FIG. 1. Parity decoding module 24 and parity encoding module 26 may perform operations described herein using software, hardware, firmware, or a mixture of hardware, software, and firmware residing in and/or executing on host 4.

In accordance with the techniques of this disclosure, host 4 may determine data to be written to data storage device 6. Parity encoding module 26 may determine parity data associated with the data. The parity data may allow recovery of a predetermined number of errors in the data. Host 4 may then send the data and the parity data, via interface 14, to memory manager unit 32 of controller 8, which may write the data to NVM 12.

In some examples, the data may be in the form of a data matrix including a number of virtual tracks, or parity encoding module 26 may arrange the data into a data matrix. The data matrix may have a number of rows equal to the number of virtual tracks and a number of columns equal to a number of sectors per virtual track. Parity encoding module 26 may receive or define the data matrix based on a received write instruction for some data and define the virtual data tracks based on how the data is being written to the NVM 12. For instance, the data matrix may have 128 rows if the data matrix contains 128 virtual tracks of data. In some instances, each virtual track may have as many as 512 sectors per track, although other examples may have more sectors per virtual track or fewer sectors per virtual track as necessary for the unique example. In some examples, the number of virtual tracks, a maximum number of correctable tracks, and the number of sectors per virtual track may be based at least in part on a sector that has a high likelihood of being affected by a subsequent write to the next track due to write head position during writing (as indicated by the position error signal)). In some examples, the virtual tracks may correspond to tracks of data in NVM 12 upon which controller 8 performs track-ECC techniques. Regardless, the data matrix may have a pre-defined size or the size may be selectable by host 4 or parity encoding module 26 prior to executing the techniques described herein. Further, parity data may be determined by controller 8 based on the received data, such as in the form of a parity matrix. In other examples, parity encoding module 26 may generate the parity data based on the data to be written to NVM 12 and send the parity data to controller 8 via interface 14.

In examples in which parity encoding module 26 generates a parity matrix, parity encoding module 26 of host 4 may determine an integration matrix based at least in part on the number of virtual tracks and a maximum number of correctable tracks of the data matrix (integrated tracks). The integration matrix may be a Cauchy matrix with a number of rows equal to a number of integrated tracks, which may refer to a number of ECC correctable tracks, of the data matrix and a number of columns equal to the number of virtual tracks of the data matrix. A Cauchy matrix is defined as having the form:

$${a}_{ij} = \frac{1}{{x}_{i} - {y}_{j}} ; {x}_{i} - {y}_{j} \neq 0 , 1 \leq i \leq m , 1 \leq j \leq n$$

where xᵢ and yⱼ are elements of a field [symbol] , and (xᵢ) and (yⱼ) are injective sequences (meaning that they do not contain repeated elements, or that the elements are distinct).

Since the integration matrix has the same number of columns as the data matrix has rows (both equal to the number of virtual tracks of the data matrix), parity encoding module 26 may cross multiply the integration matrix and the data matrix. As such, parity encoding module 26 of host 4 may determine, based at least in part on the data matrix and the integration matrix, a parity matrix. For example, host 4 may cross multiply the integration matrix and the data matrix, and then may further manipulate the product of the cross-multiplication to determine the parity matrix. In some examples, the parity matrix may have dimensions such that the number of rows is equal to the number of integrated/ECC correctable tracks (i.e., the number of rows in the integration matrix) and that the number of columns is equal to a number of parity bits at each integrated track.

In some examples, in determining the parity matrix, parity encoding module 26 may cross multiply the data matrix and the integration matrix to obtain a cross track matrix i.e., cross track matrix=integration matrix×data matrix). The cross track matrix may have a number of rows equal to the number of integrated/FCC correctable tracks (i.e., the number of rows in the integration matrix) and a number of columns equal to the number of sectors per track in the data matrix (i.e., the number of columns in the data matrix). Parity encoding module 26 may then determine an encoder matrix. The encoder matrix may include a Cauchy matrix with a number of rows equal to a number of parity bits or parity sectors for each integrated track and a number of columns equal to the number of sectors per virtual data track. To determine the parity matrix, parity encoding module 26 may cross multiply the cross track matrix and the encoder matrix (i.e., parity matrix=cross track matrix×encoder matrix).

Parity encoding module 26 of host 4 may then cause the data matrix and the parity matrix to be written to NVM 12 by sending the data matrix and the parity matrix to controller 8. Later, in response to sending a read request to controller 8 and receiving the data matrix and the parity matrix from NVM 12, parity decoding matrix 24 of host 4 may read the data matrix and use the parity matrix to recover one or more sectors in the data matrix that contain an error, as described below.

When host 4 is causing controller 8 to read the data from NVM 12, host 4 may receive parity data and data, e.g., from hardware engine 10 via controller 8. Host 4 may also receive one or more error pointers. Each respective error pointer may reference a location of a respective data sector of the data that contains an error.

Parity decoding module 24 may determine, based at least in part on the one or more error pointers, a first data sector of the data that contains an error. For instance, the received data may include ten different data sectors, or subdivisions of a track on NVM 12 that stores a fixed amount of user-accessible data. The received error pointers may reference data sector four of the ten data sectors. As such, parity decoding module 24 may determine that the fourth data sector contains an error.

Parity decoding module 24 may then recover the fourth data sector based at least in part on the parity data, the data, and the one or more error pointers. For instance, using the parity data and error correction techniques that may utilize the data and the error pointer, parity decoding module 24 may recover the fourth data sector, such that the data is in a usable state.

As described above, in some examples, the data is a data matrix. In some such examples, the one or more error pointers reference a location of a respective data sector within the data matrix (e.g., an entry in the data matrix) that contains an error. Based at least in part on the number of virtual tracks and a maximum number of correctable tracks of the data matrix (both of which are predefined or selectable, for example, based on a sector that has a high likelihood of being affected by a subsequent write to the next track due to write head position during writing (as indicated by the position error signal), parity decoding module 24 may determine an integration matrix. The integration matrix may be a Cauchy matrix with a number of rows equal to a number of integrated tracks (or the number of host ECC correctable tracks), of the data matrix and a number of columns equal to the number of virtual tracks of the data matrix.

Parity decoding module 24 may determine an integrated syndrome matrix based at least in part on the data matrix, the parity matrix, and the integration matrix. In order to utilize the data matrix for calculations, parity decoding module 24 may first insert a null value (i.e., 0) into each sector of the data matrix that contains an error (as defined by the one or more error pointers). Parity decoding module 24 may then cross multiply the integration matrix with the filled-in data matrix to obtain a modified cross track matrix (e.g., modified cross track matrix=integration matrix×data matrix) with a number of rows equal to the number of virtual tracks of the data matrix that contain an error (i.e., the number of rows in the integration matrix) and a number of columns equal to the number of sectors per virtual track (i.e., the number of columns in the data matrix). Parity decoding module 24 may cross multiply the modified cross track matrix with a transpose of the encoder matrix used in encoding the data matrix, with a number of columns equal to the number of parity bits or parity sectors for each integrated track of the data matrix and a number of rows equal to the number of sectors per virtual track (i.e., the number of columns in the data matrix) in order to obtain a modified parity matrix (i.e., modified parity matrix=modified cross track matrix×transposed encoder matrix) with a size equal to the parity matrix. When parity decoding module 24 combines the modified parity matrix and the parity matrix using an exclusive disjunction operation (XOR operation), the resulting matrix is the integrated syndrome matrix with a size equal to the parity matrix.

Parity decoding module 24 may then determine a decoupled syndrome matrix based at least in part on the integrated syndrome matrix and the number of virtual tracks of the data matrix that contain an error. For instance, parity decoding module 24 may determine which tracks of the data matrix contain an error. Parity decoding module 24 may then create one or more pointers, where each of the one or more pointers corresponds to a respective error track of the tracks of the data matrix that contain an error. Further, the respective pointer references a column in the integration matrix corresponding to the respective error track. For instance, if track 6 of the data matrix contains an error, parity decoding module 24 may create a pointer to column 6 of the integration matrix. Using these pointers for each integrated track in the data matrix that contains an error, parity decoding module 24 may determine a submatrix of the integration matrix that results in a square matrix with a number of rows and a number of columns equal to the number of virtual tracks of the data matrix that contain an error. For instance, if tracks 6, 17, 54, and 109 in the data matrix contain an error, the integration matrix would only have four rows. To create the submatrix, parity decoding module 24 may extract columns 6, 17, 54, and 109 of the integration matrix to create a 4-by-4 submatrix of the integration matrix.

Due to the construction of Cauchy matrices, a submatrix of a Cauchy matrix will also be a Cauchy matrix, and square Cauchy matrices are invertible. The inverse of a square Cauchy matrix can be defined as:

bᵢⱼ=(xⱼ−yᵢ)Aⱼ(yᵢ)Bᵢ(xⱼ)

where Aᵢ(x) and Bᵢ(x) are the Lagrange polynomials for (xᵢ) and (yⱼ), respectively. That is,

$${A}_{i} ( x ) = \frac{A ( x )}{{A}^{′} ( {x}_{i} ) ( x - {x}_{i} )} and {B}_{i} ( x ) = \frac{B ( x )}{{B}^{′} ( {y}_{i} ) ( x - {y}_{i} )} , \\ with$$

$$A ( x ) = {\prod }_{i = 1}^{n} ( x - {x}_{i} ) and B ( x ) = {\prod }_{i = 1}^{n} ( x - {y}_{i} ) .$$

Parity decoding module 24 may then cross multiply this inverse submatrix by the integrated syndrome matrix to determine the decoupled syndrome matrix (i.e., decoupled syndrome matrix=inverse submatrix of the integration matrix×integrated syndrome matrix).

Using the decoupled syndrome matrix, parity decoding module 24 may recover a data sector in a track of the data matrix that contains an error. For instance, parity decoding module 24 may determine a square submatrix of the Cauchy encoder matrix (used in determining the integrated syndrome matrix) with a number of rows and columns equal to the number of parity bits or parity sectors for each integrated track of data. The submatrix may span each row of the Cauchy encoder matrix and may begin at a column that is equal to a column of a data sector that contains an error for the current track being recovered. For instance, if track 6 contains an error in sectors 22, 153, and 234, the encoder matrix would have three rows (as there are three sectors that need correcting). Similarly as to the process described above with respect to how the submatrix of the integration matrix is determined, parity decoding module determine a respective index for the three error sectors and may extract columns 22, 153, and 234 of the encoder matrix to determine a 3-by-3 submatrix of the encoder matrix. Parity decoding module 24 may then invert the submatrix of the encoder matrix according to the Cauchy matrix principles described above.

Parity decoding module 24 may also determine a submatrix of the decoupled syndrome matrix. The submatrix of the decoupled syndrome matrix may be a single row of the decoupled syndrome matrix, such as the first row. Parity decoding module 24 may cross multiply the submatrix of the decoupled syndrome matrix with the inverse of the determined submatrix of the encoder matrix to obtain a vector of the recovered data sector in the given error track (i.e., vector=submatrix of the decoupled syndrome matrix×inverted submatrix of the encoder matrix). Parity decoding module 24 may use the vector to recover the errored data sectors in the track of the data matrix (e.g., track 6, in this example), such as by replacing the contents of the errored data sector with the contents of the vector.

By using the techniques described above, host 4, controller 8, or both may omit the inefficient write verify function, which may increase the operating efficiency (e.g., write throughput) of the hard drive an SMR disk drive). Rather than performing the write verify function upon writing, the use of the parity matrix that to recover various sectors in tracks of data may increase the speed and efficiency of host 4 in managing the cold storage SMR drive with a minimal additional burden of storing the parity matrix data. Further, when compared to other data recovery techniques, using the matrix calculations and Cauchy matrices described herein may result in a more efficient recovery of the error-laden data matrix.

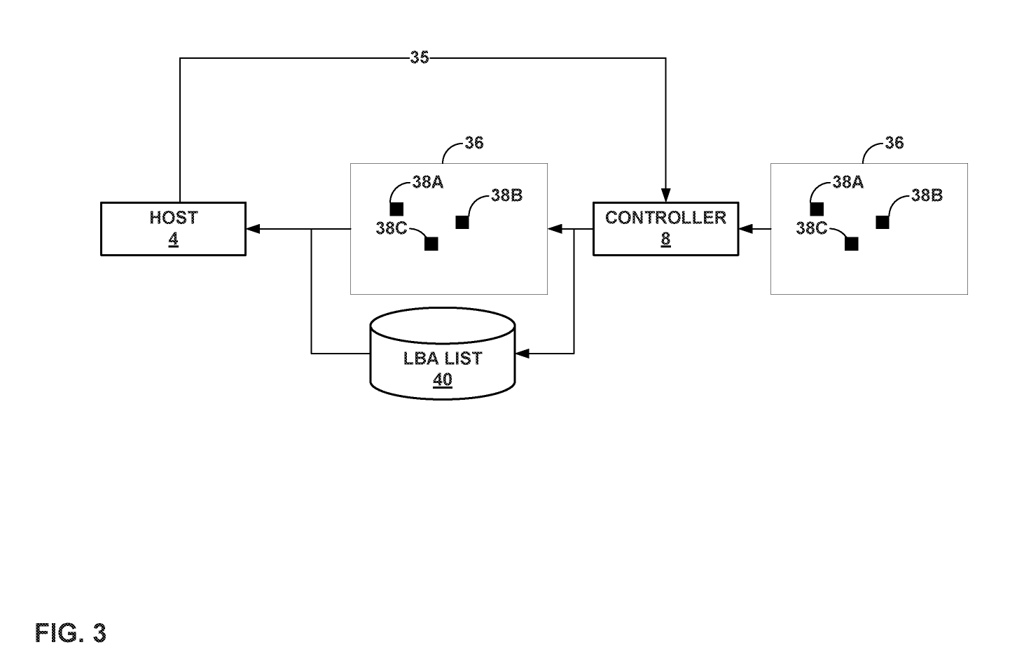

FIG. 3 is a conceptual diagram illustrating an example process of a host device receiving error-laden data and a logical block address list from a controller device, in accordance with one or more techniques of this disclosure. In the example of FIG. 3, data matrix 36 may be an error-laden data matrix that includes errors in data sectors 38A, 38B, and 38C. Data matrix 36 may be stored on a storage device, such as NVM 12 of data storage device 6 of FIG. 1.

In the example of FIG. 3, host 4 may output a request to controller 8 to retrieve data matrix 36 from a storage device, such as NVM 12 of FIG. 1. In response to receiving that request, controller 8 may retrieve data matrix 36 from the storage device. Controller 8 may determine whether data matrix 36 includes any errors. In the example of FIG. 3, data matrix 36 includes three errors at data sectors 38A, 38B, and 38C. As such, controller 8 may create three error pointers referencing data sectors 38A, 38B, and 38C.

In some examples, once controller 8 retrieves data matrix 36 from NVM 12, controller 8 may perform an ECC technique, such as track ECC, to recover at least some of the errors present in data matrix 36. For instance, suppose data matrix 36 includes seven errors. Controller 8 may perform a track ECC technique to recover a portion of those errors, such as four of the seven errors. After recovering at least some of the errors present in data matrix 36, controller 8 may identify any unrecovered errors and create error pointers referencing the data sectors for the unrecovered errors.

Host 4 may then receive data matrix 36 from controller 8, with data matrix 36 still including the errors at data sectors 38A, 38B, and 38C. Host 4 may also receive the one or more error pointers referencing the three errors from controller 8. In the example of FIG. 3, host 4 may receive the error pointers in the form of logical block address (LBA) list 40. In other examples, the error pointers may take any other form sufficient for referencing the location of the three error-laden data sectors, including a plurality of individual pointer elements. Host 4 may then utilize the techniques described herein to recover one or more of the error-laden data sectors 38A, 38B, and/or 38C present in data matrix 36.

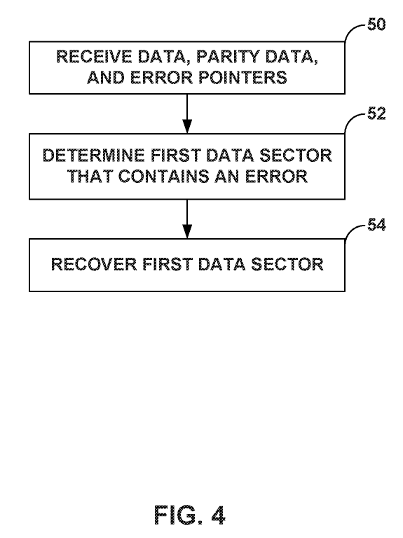

FIG. 4 is a flow diagram illustrating an exemplary operation of a host device in performing the error-correcting code operations, in accordance with one or more techniques of this disclosure. For the purposes of illustration only, reference will be made to structures of FIG. 1 in describing the functionality performed in accordance with the techniques of this disclosure.

In accordance with the techniques of this disclosure, in response to host 4 causing controller 8 to read the data from NVM 12, host 4 may receive parity data and data, e.g., from hardware engine 10 via controller 8. Host 4 may also receive one or more error pointers (50). Each respective error pointer may reference a location of a respective data sector of the data that contains an error.

Host 4 may determine, based at least in part on the one or more error pointers, a first data sector of the data that contains an error (52). For instance, the received data may include ten different data sectors, or subdivisions of a track on NVM 12 that stores a fixed amount of user-accessible data. The received error pointers may reference data sectors three and seven of the ten data sectors. As such, host 4 may determine that the third data sector and the seventh data sector contain errors.

Host 4 may then recover the first data sector based at least in part on the parity data, the data, and the one or more error pointers (54). For instance, using the parity data and error correction techniques that may utilize the data and the one or more error pointers, host 4 may recover the third data sector and/or the seventh data sector, such that the data is in a usable state.

In some examples, host 4 may generate the parity data prior to causing controller 8 to write data to NVM 12. For example, host 4 may generate the parity data based on the data to be written to NVM 12, and may communicate the data and the parity data to controller 8 with an instruction to controller 8 to write the data to NVM 12.

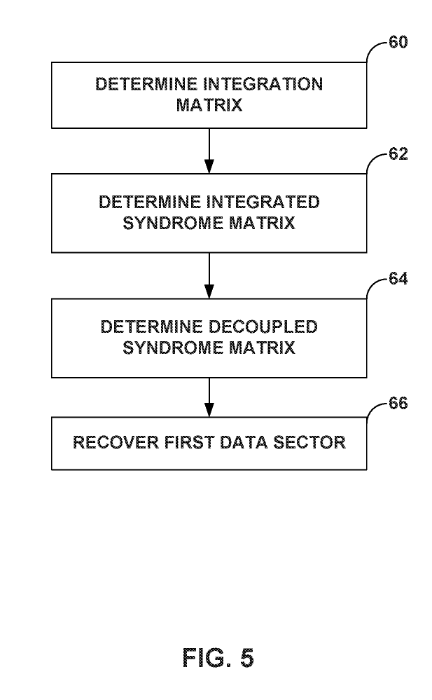

FIG. 5 is a flow diagram illustrating an exemplary operation of a host device in performing a particular error-correcting code operation, in accordance with one or more techniques of this disclosure. For the purposes of illustration only, reference will be made to structures of FIG. 1 in describing the functionality performed in accordance with the techniques of this disclosure.

In some examples, the data received by host 4, as described above with respect to FIG. 4, may be in the form of a data matrix including a number of virtual tracks. The data matrix may have a number of rows equal to the number of virtual tracks and a number of columns equal to a number of sectors per virtual track. For instance, the data matrix may have 8 rows if the data matrix contains 8 tracks of data. In some instances, each track may have as many as 512 sectors per track, although other examples may have more sectors per track or fewer sectors per track as necessary for the unique example. In some examples, the number of virtual tracks, the maximum number of correctable tracks, and the number of sectors per virtual track may be based at least in part on a sector that has a high likelihood of being affected by a subsequent write to the next track due to write head position during writing (as indicated by the position error signal). Regardless, the data matrix may have a pre-defined size or selectable by host 4 prior to executing the techniques described herein. Further, the parity data received by host 4 may be a parity matrix determined by parity encoding module 26 or controller 8 prior to the data being written to NVM 12. In such examples, the one or more error pointers reference a location of a respective data sector within the data matrix that contains an error.

In such examples where the data is a data matrix, based at least in part on the number of virtual tracks and a maximum number of correctable tracks of the data matrix (both of which are predefined or selectable, for example, based on a sector that has a high likelihood of being affected by a subsequent write to the next track due to write head position during writing (as indicated by the position error signal)), host 4 may determine an integration matrix (60). The integration matrix may be a Cauchy matrix with a number of rows equal to a number of integrated tracks (or the number of host FCC correctable tracks), of the data matrix and a number of columns equal to the number of virtual tracks of the data matrix.

Host 4 may determine an integrated syndrome matrix based at least in part on the data matrix, the parity matrix, and the integration matrix (62). In order to utilize the data matrix for calculations, host 4 may first insert a null value (i.e., 0) into each sector of the data matrix that contains an error (as defined by the one or more error pointers). Host 4 may then cross multiply the integration matrix with the filled-in data matrix to obtain a modified cross track matrix (e.g., modified cross track matrix=integration matrix×data matrix) with a number of rows equal to the number of virtual tracks of the data matrix that contain an error (i.e., the number of rows in the integration matrix) and a number of columns equal to the number of sectors per virtual track (i.e., the number of columns in the data matrix). Host 4 may cross multiply the modified cross track matrix with a transpose of the encoder matrix used in encoding the data matrix, with a number of columns equal to the number of parity bits for each integrated track of the data matrix and a number of rows equal to the number of sectors per virtual track (i.e., the number of columns in the data matrix) in order to obtain a modified parity matrix (i.e., modified parity matrix=modified cross track matrix×transposed encoder matrix) with a size equal to the parity matrix. When host 4 combines the modified parity matrix and the parity matrix using an exclusive disjunction operation (XOR operation), the resulting matrix is the integrated syndrome matrix with a size equal to the parity matrix.

Host 4 may then determine a decoupled syndrome matrix based at least in part on the integrated syndrome matrix and the number of virtual tracks of the data matrix that contain an error (64). For instance, host 4 may determine which tracks of the data matrix contain an error. Host 4 may then create one or more pointers, where each of the one or more pointers corresponds to a respective error track of the tracks of the data matrix that contain an error. Further, the respective pointer references a column in the integration matrix corresponding to the respective error track. For instance, if track 6 of the data matrix contains an error, host 4 may create a pointer to column 6 of the integration matrix. Using these pointers for each integrated track in the data matrix that contains an error, host 4 may determine a submatrix of the integration matrix that results in a square matrix with a number of rows and a number of columns equal to the number of virtual tracks of the data matrix that contain an error. For instance, if tracks 6, 17, 54, and 109 in the data matrix contain an error, the integration matrix would only have four rows. To create the submatrix, host 4 may extract columns 6, 17, 54, and 109 of the integration matrix to create a 4-by-4 submatrix of the integration matrix.

Due to the construction of Cauchy matrices, a submatrix of a Cauchy matrix will also be a Cauchy matrix, and square Cauchy matrices are invertible. Host 4 may then cross multiply this inverse submatrix by the integrated syndrome matrix to determine the decoupled syndrome matrix (i.e., decoupled syndrome matrix=inverse submatrix of the integration matrix×integrated syndrome matrix).

Using the decoupled syndrome matrix, host 4 may recover a data sector in a track of the data matrix that contains an error (66). For instance, host 4 may determine a square submatrix of the Cauchy encoder matrix (used in determining the integrated syndrome matrix) with a number of rows and columns equal to the number of parity bits for each integrated track of data. The submatrix may span each row of the Cauchy encoder matrix and may begin at a column that is equal to a column of a data sector that contains an error for the current track being recovered. For instance, if track 4 contains an error in sectors 22, 153, and 234, the encoder matrix would have three rows (as there are three sectors that need correcting). Similarly as to the process described above with respect to how the submatrix of the integration matrix is determined, parity decoding module determine a respective index for the three error sectors and may extract columns 22, 153, and 234 of the encoder matrix to determine a 3-by-3 submatrix of the encoder matrix. Host 4 may then invert the submatrix of the encoder matrix according to the Cauchy matrix principles described above.

Host 4 may also determine a submatrix of the decoupled syndrome matrix. The submatrix of the decoupled syndrome matrix may be a single row of the decoupled syndrome matrix, such as the first row. Host 4 may cross multiply the submatrix of the decoupled syndrome matrix with the inverse of the determined submatrix of the encoder matrix to obtain a vector of the recovered data sector in the given error track (i.e., vector=submatrix of the decoupled syndrome matrix×inverted submatrix of the encoder matrix). Host 4 may use the vector to recover the errored data sectors in the track of the data matrix (e.g., track 6, in this example).

By using the techniques described above, host 4 may omit the inefficient write verify function, which may increase the operating efficiency (e.g., write throughput) of the hard drive (e.g., an SMR disk drive). Rather than performing the write verify function upon writing, the use of the parity matrix that to recover various sectors in tracks of data may increase the speed and efficiency of host 4 in managing the cold storage SMR drive with a minimal additional burden of storing the parity matrix data. Further, when compared to other data recovery techniques, using the matrix calculations and Cauchy matrices described herein may result in a more efficient recovery of the error-laden data matrix.

### EXAMPLE 1

A method comprising: receiving, by a host device and from a storage device, parity data, data and one or more error pointers, wherein each respective error pointer references a location of a respective data sector of the data that contains an error; determining, by the host device and based at least in part on the one or more error pointers, a first data sector of the data that contains an error; and recovering, by the host device and based at least in part on the parity data, the data, and the one or more error pointers, the first data sector.

### EXAMPLE 2

The method of example 1, further comprising: receiving, by the host device, track error correction code (track-ECC) data, wherein recovering the first data sector comprises recovering, by the host device and based at least in part on the track-ECC data, the parity data, the data, and the one or more error pointers, the first data sector.

### EXAMPLE 3

The method of any of examples 1-3, wherein the data comprises a data matrix comprising a number of virtual data tracks, wherein each virtual data track comprises a plurality of data sectors, wherein the data matrix has a number of rows equal to a first value and a number of columns equal to a second value, wherein the first value comprises the number of virtual tracks, wherein the second value comprises a number of data sectors per virtual track, and wherein the parity data comprises a parity matrix.

### EXAMPLE 4

The method of example 3, wherein recovering the first data sector comprises: determining, by the host device and based at least in part on the number of virtual tracks and a number of tracks of the data matrix that contain an error, an integration matrix; determining, by the host device and based at least in part on the data matrix, the parity matrix, and the integration matrix, an integrated syndrome matrix; determining, by the host device and based at least in part on the integrated syndrome matrix and the number of tracks of the data matrix that contain an error, a decoupled syndrome matrix; and recovering, by the host device and based at least in part on the decoupled syndrome matrix, the first data sector.

### EXAMPLE 5

The method of example 4, wherein the integration matrix comprises a Cauchy integration matrix with a number of rows equal to the number of tracks of the data matrix that contain an error and with a number of columns equal to the first value.

### EXAMPLE 6

The method of examples 5, wherein one or more of the number of virtual tracks, the number of tracks of the data matrix that contain an error, and the number of data sectors per virtual track are user-defined.

### EXAMPLE 7

The method of any of examples 5-6, wherein determining the integrated syndrome matrix comprises: for each of the one or more error pointers, inserting, by the host device, a null value into the respective data sector referenced by each of the one or more pointers; determining, by the host device, a modified cross track matrix by cross multiplying the data matrix and the integration matrix; determining, by the host device, an encoder matrix, wherein the encoder matrix comprises a Cauchy matrix with a number of rows equal to a number of parity sectors for each virtual track and a number of columns equal to the second value; determining, by the host device, a modified parity matrix by cross multiplying the modified cross track matrix and the encoder matrix; and determining, by the host device, the integrated syndrome matrix by performing an exclusive disjunction operation on the modified parity matrix and the parity matrix.

### EXAMPLE 8

The method of example 7, wherein determining the decoupled syndrome matrix comprises: determining, by the host device, a submatrix of the integration matrix, wherein the submatrix of the integration matrix comprises each column that contains a location referenced by the one or more error pointers; determining, by the host device, an inverse of the submatrix of the integration matrix; and determining, by the host device, the decoupled syndrome matrix by cross multiplying the inverse of the submatrix and the integrated syndrome matrix.

### EXAMPLE 9

The method of any of examples 4-8, wherein recovering the first data sector comprises: determining, by the host device, a submatrix of the decoupled syndrome matrix, wherein the submatrix of the decoupled syndrome matrix comprises a single row of the decoupled syndrome matrix; determining, by the host device, an encoder matrix, wherein the encoder matrix comprises a Cauchy matrix with a number of rows equal to a number of parity sectors for each track and a number of columns equal to the second value; determining, by the host device, a respective index of each data sector in the track of the data matrix that contains an error; determining, by the host device, a submatrix of the encoder matrix, wherein the submatrix of the encoder matrix comprises columns of the encoder matrix that match the respective indexes; determining, by the host device, an inverse of the submatrix of the encoder matrix; and determining, by the host device, a recovery vector of the first data sector by cross multiplying the submatrix of the decoupled syndrome matrix and the inverse of the submatrix of the encoder matrix.

### EXAMPLE 10

The method of any of examples 3-9, wherein the data matrix has a pre-defined size.

### EXAMPLE 11

A host device comprising: at least one processor; and a storage device configured to store one or more modules operable by the at least one processor to: receive, from a storage device, parity data, data and one or more error pointers, wherein each respective error pointer references a location of a respective data sector of the data that contains an error; determine, based at least in part on the one or more error pointers, a first data sector of the data that contains an error; and recover, based at least in part on the parity data, the data, and the one or more error pointers, the first data sector.

### EXAMPLE 12

The host device of example 11, wherein the one or more modules are further operable by the at least one processor to: receive track error correction code (track-ECC) data, wherein the one or more modules being operable to recover the first data sector comprises the one or more modules being operable by the at least one processor to recover, based at least in part on the track-ECC data, the parity data, the data, and the one or more error pointers, the first data sector.

### EXAMPLE 13

The host device of any of examples 11-12, wherein the data comprises a data matrix comprising a number of virtual data tracks, wherein each virtual data track comprises a plurality of data sectors, wherein the data matrix has a number of rows equal to a first value and a number of columns equal to a second value, wherein the first value comprises the number of virtual tracks, wherein the second value comprises a number of data sectors per virtual track, and wherein the parity data comprises a parity matrix, wherein the one or more modules being operable to recover the first data sector comprises the one or more modules being operable by the at least one processor to: determine, based at least in part on the number of virtual tracks and a number of tracks of the data matrix that contain an error, an integration matrix; determine, based at least in part on the data matrix, the parity matrix, and the integration matrix, an integrated syndrome matrix; determine, based at least in part on the integrated syndrome matrix and the number of tracks of the data matrix that contain an error, a decoupled syndrome matrix; and recover, based at least in part on the decoupled syndrome matrix, a data sector in a track of the data matrix that contains an error.

### EXAMPLE 14

The host device of example 13, wherein the integration matrix comprises a Cauchy integration matrix with a number of rows equal to the number of tracks of the data matrix that contain an error and with a number of columns equal to the first value.

### EXAMPLE 15

The host device of example 14, wherein one or more of the number of virtual tracks, the number of tracks of the data matrix that contain an error, and the number of data sectors per virtual track are user-defined.

### EXAMPLE 16

The host device of example 15, wherein the one or more modules being operable to determine the integrated syndrome matrix comprises the one or more modules being operable by the at least one processor to: for each of the one or more error pointers, insert a null value into the respective data sector referenced by each of the one or more pointers; determine a modified cross track matrix by cross multiplying the data matrix and the integration matrix; determine an encoder matrix, wherein the encoder matrix comprises a Cauchy matrix with a number of rows equal to a number of parity sectors for each virtual track and a number of columns equal to the second value; determine a modified parity matrix by cross multiplying the modified cross track matrix and the encoder matrix; and determine the integrated syndrome matrix by performing an exclusive disjunction operation on the modified parity matrix and the parity matrix.

### EXAMPLE 17

The host device of example 16, wherein the one or more modules being operable to determine the decoupled syndrome matrix comprises the one or more modules being operable by the at least one processor to: determine a submatrix of the integration matrix, wherein the submatrix of the integration matrix comprises each column referenced by the one or more pointers; determine an inverse of the submatrix of the integration matrix; and determine the decoupled syndrome matrix by cross multiplying the inverse of the submatrix and the integrated syndrome matrix.

### EXAMPLE 18

The host device of any of examples 15-17, wherein the one or more modules being operable to recover the first data sector comprises the one or more modules being operable by the at least one processor to: determine a submatrix of the decoupled syndrome matrix, wherein the submatrix of the decoupled syndrome matrix comprises a single row of the decoupled syndrome matrix; determine an encoder matrix, wherein the encoder matrix comprises a Cauchy matrix with a number of rows equal to a number of parity sectors for each track and a number of columns equal to the second value; determine a respective index of each respective data sector referenced by each respective error pointer; determine a submatrix of the encoder matrix, wherein the submatrix of the encoder matrix comprises columns of the encoder matrix that match the respective indexes; determine an inverse of the submatrix of the encoder matrix; and determine a recovery vector of the first data sector by cross multiplying the submatrix of the decoupled syndrome matrix and the inverse of the submatrix of the encoder matrix.

### EXAMPLE 19

The host device of any of examples 14-18, wherein the data matrix has a pre-defined size.

### EXAMPLE 20

A host device comprising: means for receiving, from a storage device, parity data, data, and one or more error pointers, wherein each respective error pointer references a location of a respective data sector of the data that contains an error; means for determining, based at least in part on the one or more error pointers, a first data sector that contains an error; and means for recovering, based at least in part on the parity matrix, the data matrix, and the one or more error pointers, the first data sector.

### EXAMPLE 21

A device comprising means for performing the method of any combination of examples 1-11.

### EXAMPLE 22

A computer-readable storage medium encoded with instructions that, when executed, cause at least one processor of a computing device to perform the method of any combination of examples 1-11.

### EXAMPLE 23

A device comprising at least one module operable by one or more processors to perform the method of any combination of examples 1-11.

The techniques described in this disclosure may be implemented, at least in part, in hardware, software, firmware, or any combination thereof. For example, various aspects of the described techniques may be implemented within one or more processing units, including one or more microprocessing units, digital signal processing units (DSPs), application specific integrated circuits (ASICs), field programmable gate arrays (FPGAs), graphics processing units (GPUs), or any other equivalent integrated or discrete logic circuitry, as well as any combinations of such components. The term “processing unit” or “processing circuitry” may generally refer to any of the foregoing logic circuitry, alone or in combination with other logic circuitry, or any other equivalent circuitry. A control unit including hardware may also perform one or more of the techniques of this disclosure.

Such hardware, software, and firmware may be implemented within the same device or within separate devices to support the various techniques described in this disclosure. In addition, any of the described units, modules or components may be implemented together or separately as discrete but interoperable logic devices. Depiction of different features as modules or units is intended to highlight different functional aspects and does not necessarily imply that such modules or units must be realized by separate hardware, firmware, or software components. Rather, functionality associated with one or more modules or units may be performed by separate hardware, firmware, or software components, or integrated within common or separate hardware, firmware, or software components.

The techniques described in this disclosure may also be embodied or encoded in an article of manufacture including a computer-readable storage medium encoded with instructions. Instructions embedded or encoded in an article of manufacture including a computer-readable storage medium encoded, may cause one or more programmable processing units, or other processing units, to implement one or more of the techniques described herein, such as when instructions included or encoded in the computer-readable storage medium are executed by the one or more processing units. Computer readable storage media may include random access memory (RAM), read only memory (ROM), programmable read only memory (PROM), erasable programmable read only memory (EPROM), electronically erasable programmable read only memory (EEPROM), flash memory, a hard disk, a compact disk ROM (CD-ROM), a floppy disk, a cassette, magnetic media, optical media, or other computer readable media. In some examples, an article of manufacture may include one or more computer-readable storage media.

In some examples, a computer-readable storage medium may include a non-transitory medium. The term “non-transitory” may indicate that the storage medium is not embodied in a carrier wave or a propagated signal. In certain examples, a non-transitory storage medium may store data that can, over time, change (e.g., in RAM or cache).

Various examples of the disclosure have been described. Any combination of the described systems, operations, or functions is contemplated. These and other examples are within the scope of the following claims.

1. A method comprising:
receiving, by a host device and from a storage device, parity data, data and one or more error pointers, wherein each respective error pointer references a location of a respective data sector of the data that contains an error;
determining, by the host device and based at least in part on the one or more error pointers, a first data sector of the data that contains an error; and
recovering, by the host device and based at least in part on the parity data, the data, and the one or more error pointers, the first data sector.

2. The method of claim 1, further comprising:
receiving, by the host device, track error correction code (track-ECC) data,
wherein recovering the first data sector comprises recovering, by the host device and based at least in part on the track-ECC data, the parity data, the data, and the one or more error pointers, the first data sector.

3. The method of claim 1, wherein the data comprises a data matrix comprising a number of virtual data tracks, wherein each virtual data track comprises a plurality of data sectors, wherein the data matrix has a number of rows equal to a first value and a number of columns equal to a second value, wherein the first value comprises the number of virtual tracks, wherein the second value comprises a number of data sectors per virtual track, and wherein the parity data comprises a parity matrix.

4. The method of claim 3, wherein recovering the first data sector comprises:
determining, by the host device and based at least in part on the number of virtual tracks and a number of tracks of the data matrix that contain an error, an integration matrix;
determining, by the host device and based at least in part on the data matrix, the parity matrix, and the integration matrix, an integrated syndrome matrix;
determining, by the host device and based at least in part on the integrated syndrome matrix and the number of tracks of the data matrix that contain an error, a decoupled syndrome matrix; and
recovering, by the host device and based at least in part on the decoupled syndrome matrix, the first data sector.

5. The method of claim 4, wherein the integration matrix comprises a Cauchy integration matrix with a number of rows equal to the number of tracks of the data matrix that contain an error and with a number of columns equal to the first value.

6. The method of claim 5, wherein one or more of the number of virtual tracks, the number of tracks of the data matrix that contain an error, and the number of data sectors per virtual track are user-defined.

7. The method of claim 5, wherein determining the integrated syndrome matrix comprises:
for each of the one or more error pointers, inserting, by the host device, a null value into the respective data sector referenced by each of the one or more pointers;
determining, by the host device, a modified cross track matrix by cross multiplying the data matrix and the integration matrix;
determining, by the host device, an encoder matrix, wherein the encoder matrix comprises a Cauchy matrix with a number of rows equal to a number of parity sectors for each virtual track and a number of columns equal to the second value;
determining, by the host device, a modified parity matrix by cross multiplying the modified cross track matrix and the encoder matrix; and
determining, by the host device, the integrated syndrome matrix by performing an exclusive disjunction operation on the modified parity matrix and the parity matrix.

8. The method of claim 7, wherein determining the decoupled syndrome matrix comprises:
determining, by the host device, a submatrix of the integration matrix, wherein the submatrix of the integration matrix comprises each column that contains a location referenced by the one or more error pointers;
determining, by the host device, an inverse of the submatrix of the integration matrix; and
determining, by the host device, the decoupled syndrome matrix by cross multiplying the inverse of the submatrix and the integrated syndrome matrix.

9. The method of claim 4, wherein recovering the first data sector comprises:
determining, by the host device, a submatrix of the decoupled syndrome matrix, wherein the submatrix of the decoupled syndrome matrix comprises a single row of the decoupled syndrome matrix;
determining, by the host device, an encoder matrix, wherein the encoder matrix comprises a Cauchy matrix with a number of rows equal to a number of parity sectors for each track and a number of columns equal to the second value;
determining, by the host device, a respective index of each data sector in track of the data matrix that contains an error;
determining, by the host device, a submatrix of the encoder matrix, wherein the submatrix of the encoder matrix comprises columns of the encoder matrix that match the respective indexes;
determining, by the host device, an inverse of the submatrix of the encoder matrix; and
determining, by the host device, a recovery vector of the first data sector by cross multiplying the submatrix of the decoupled syndrome matrix and the inverse of the submatrix of the encoder matrix.

10. The method of claim 3, wherein the data matrix has a pre-defined size.

11. A host device comprising:
at least one processor; and
a storage device configured to store one or more modules operable by the at least one processor to:
receive, from a storage device, parity data, data and one or more error pointers, wherein each respective error pointer references a location of a respective data sector of the data that contains an error;
determine, based at least in part on the one or more error pointers, a first data sector of the data that contains an error; and
recover, based at least in part on the parity data, the data, and the one or more error pointers, the first data sector.

12. The host device of claim 11, wherein the one or more modules are further operable by the at least one processor to:
receive track error correction code (track-ECC) data,
wherein the one or more modules being operable to recover the first data sector comprises the one or more modules being operable by the at least one processor to recover, based at least in part on the track-ECC data, the parity data, the data, and the one or more error pointers, the first data sector.

13. The host device of claim 11, wherein the data comprises a data matrix comprising a number of virtual data tracks, wherein each virtual data track comprises a plurality of data sectors, wherein the data matrix has a number of rows equal to a first value and a number of columns equal to a second value, wherein the first value comprises the number of virtual tracks, wherein the second value comprises a number of data sectors per virtual track, and wherein the parity data comprises a parity matrix, wherein the one or more modules being operable to recover the first data sector comprises the one or more modules being operable by the at least one processor to:
determine, based at least in part on the number of virtual tracks and a number of tracks of the data matrix that contain an error, an integration matrix;
determine, based at least in part on the data matrix, the parity matrix, and the integration matrix, an integrated syndrome matrix;
determine, based at least in part on the integrated syndrome matrix and the number of tracks of the data matrix that contain an error, a decoupled syndrome matrix; and
recover, based at least in part on the decoupled syndrome matrix, a data sector in a track of the data matrix that contains an error.

14. The host device of claim 13, wherein the integration matrix comprises a Cauchy integration matrix with a number of rows equal to the number of tracks of the data matrix that contain an error and with a number of columns equal to the first value.

15. The host device of claim 14, wherein one or more of the number of virtual tracks, the number of tracks of the data matrix that contain an error, and the number of data sectors per virtual track are user-defined.

16. The host device of claim 15, wherein the one or more modules being operable to determine the integrated syndrome matrix comprises the one or more modules being operable by the at least one processor to:
for each of the one or more error pointers, insert a null value into the respective data sector referenced by each of the one or more pointers;
determine a modified cross track matrix by cross multiplying the data matrix and the integration matrix;
determine an encoder matrix, wherein the encoder matrix comprises a Cauchy matrix with a number of rows equal to a number of parity sectors for each virtual track and a number of columns equal to the second value;
determine a modified parity matrix by cross multiplying the modified cross track matrix and the encoder matrix; and
determine the integrated syndrome matrix by performing an exclusive disjunction operation on the modified parity matrix and the parity matrix.

17. The host device of claim 16, wherein the one or more modules being operable to determine the decoupled syndrome matrix comprises the one or more modules being operable by the at least one processor to:
determine a submatrix of the integration matrix, wherein the submatrix of the integration matrix comprises each column referenced by the one or more pointers;
determine an inverse of the submatrix of the integration matrix; and
determine the decoupled syndrome matrix by cross multiplying the inverse of the submatrix and the integrated syndrome matrix.

18. The host device of claim 15, wherein the one or more modules being operable to recover the first data sector comprises the one or more modules being operable by the at least one processor to:
determine a submatrix of the decoupled syndrome matrix, wherein the submatrix of the decoupled syndrome matrix comprises a single row of the decoupled syndrome matrix;
determine an encoder matrix, wherein the encoder matrix comprises a Cauchy matrix with a number of rows equal to a number of parity sectors for each track and a number of columns equal to the second value;
determine a respective index of each respective data sector referenced by each respective error pointer;
determine a submatrix of the encoder matrix, wherein the submatrix of the encoder matrix comprises columns of the encoder matrix that match the respective indexes;
determine an inverse of the submatrix of the encoder matrix; and
determine a recovery vector of the first data sector by cross multiplying the submatrix of the decoupled syndrome matrix and the inverse of the submatrix of the encoder matrix.

19. The host device of claim 14, wherein the data matrix has a pre-defined size.

20. A host device comprising:
means for receiving, from a storage device, parity data, data, and one or more error pointers, wherein each respective error pointer references a location of a respective data sector of the data that contains an error;
means for determining, based at least in part on the one or more error pointers, a first data sector that contains an error; and
means for recovering, based at least in part on the parity matrix, the data matrix, and the one or more error pointers, the first data sector.
